(19) United States
(12) Patent Application Publication
(10) Pub. No.: US 2003/0069049 A1
(43) Pub. Date: Apr. 10, 2003

(54) Method and arrangement for gain control

(76) Inventors: Timo Poranen, Oulu (FI); Pekka Adolfsen, Oulu (FI); Andre Dekker, Oulu (FI)

Correspondence Address: PILLSBURY WINTHROP, LLP, P.O. BOX 10500, MCLEAN, VA, 22102, US

(21) Appl. No.: 10/238,895

(22) Filed: Sep. 11, 2002

Related U.S. Application Data
(63) Continuation of application No. PCT/FI01/00240, filed on Mar. 12, 2001.

(30) Foreign Application Priority Data
Mar. 13, 2000 (FI) 20000576

(51) Int. Cl. H04B 1/00; H04B 7/00; H04M 1/00; H04B 1/38

(52) U.S. Cl. 455/572; 455/68

(57) ABSTRACT

The invention relates to a method and an arrangement implementing the method for gain control. In the method, a signal is modulated and the modulated signal is amplified with a power amplifier (312) to an output (313). A modulated signal of a given timeslot is applied to a control unit (323) before the power amplifier (312). Said amplified modulated signal is applied from the output (313) to the control unit (323). The signals are compared in the control unit, in which a control signals is also generated based on the comparison. The gain is controlled based on the control signal in a following at least one timeslot. The gain may also be controlled between timeslots, based on the control signal.

This application is a continuation of international application PCT/FI01/00240 filed Dec. 3, 2001, which designated the US and was published under PCT article 21(2) in English.

### FIELD OF THE INVENTION

The invention relates to a method and an arrangement implementing the method for non-real-time gain control of a transmitter. The solution of the invention is typically usable in a transmitter of the TDMA radio system.

### BACKGROUND OF THE INVENTION

FIG. 1 shows a prior art solution, wherein gain control in a base station transmitter is implemented analogically and using feedback. A modulated constant-amplitude input signal is attenuated to the desired power level with an attenuator 100. The attenuated signal is amplified with a power amplifier 102 to an output 103 and a feedback 104, wherein the signal is detected with a power detector 106. The detected signal is applied to an adder 108, wherein it is added to a power setting signal. Said addition generates a control signal, which is filtered in a filter 110, whereupon the control signal is used for gain control to adjust the output power to the desired level.

Once the signal is amplitude-modulated, and control is to be fast, the prior art solution distorts the modulation. When control it to be slow, the prior art solution has no time to follow fast power setting alterations. Thus, the prior art solution suffers significant drawbacks when a signal is amplitude-modulated.

### BRIEF DESCRIPTION OF THE INVENTION

The object of the invention is to provide a method and an arrangement implementing the method so that gain control is accurate and the gain control of the invention does not distort modulation. This is achieved with a method for gain control, in which method a signal is modulated and the modulated signal is amplified with a power amplifier to an output. The method further comprises applying a modulated signal of a given timeslot before the power amplifier to a control unit, applying said amplified modulated signal from the output to the control unit, comparing the signals in the control unit, generating a control signal in the control unit based on the comparison, and adjusting the gain based on the control signal in a following at least one timeslot.

The invention also relates to a method for gain control, in which method a signal is modulated and the modulated signal is amplified with a power amplifier to an output. The method further comprises applying a modulated signal of a given timeslot before the power amplifier to a control unit, applying said amplified modulated signal from the output to the control unit, comparing the signals in the control unit, generating a control signal in the control unit based on the comparison, and adjusting the gain based on the control signal between timeslots.

The invention further relates to an arrangement for gain control, the arrangement comprising a modulator for modulating a signal and a power amplifier for amplifying the modulated signal to an output. The arrangement also comprises a control unit for comparing a modulated signal of a given timeslot, applied to the control unit before the power amplifier, with a modulated amplified signal of said given timeslot, applied to the control unit after the poser amplifier, and for generating a control signal based on said comparison, and a controller for gain control in a following at least one timeslot based on the control signal.

The invention still further relates to an arrangement for gain control, the arrangement comprising a modulator for modulating a signal and a power amplifier for amplifying the modulated signal to an output. The arrangement also comprises a control unit for comparing a modulated signal of a given timeslot, applied to the control unit before the power amplifier, with a modulated amplified signal of said given timeslot, applied to the control unit after the power amplifier, and for generating a control signal based on said comparison, and a controller for gain control between timeslots based on the control signal.

The preferred embodiments of the invention are disclosed in the dependent claims.

The invention is based on comparing, in the control unit, a modulated signal of a given timeslot, applied to the control unit before the power amplifier, with said modulated amplified signal of a given timeslot, applied to the control unit after the power amplifier. A control signal is generated in the control unit based on said comparison. Power is controlled based on the control signal in a following at least one timeslot. Power can be controlled based on the control signal also between timeslots. The above gain control is used to adjust an output signal towards an ideal value.

The method and arrangement of the invention can be used to adjust the power of an amplitude-modulated signal at good regulation accuracy. The solution of the invention meets the requirements of both a wide dynamic area and high speed.

### BRIEF DESCRIPTION OF THE FIGURES

FIG. 1 shows a prior art solution,

FIG. 2 is a basic block diagram of the solution of the invention,

FIG. 3 shows a preferred embodiment of the invention,

FIG. 4A shows a solution of analogically implemented up-conversion,

FIG. 4B shows a solution of digitally implemented up-conversion,

FIGS. 5A and 5B show signal processing models.

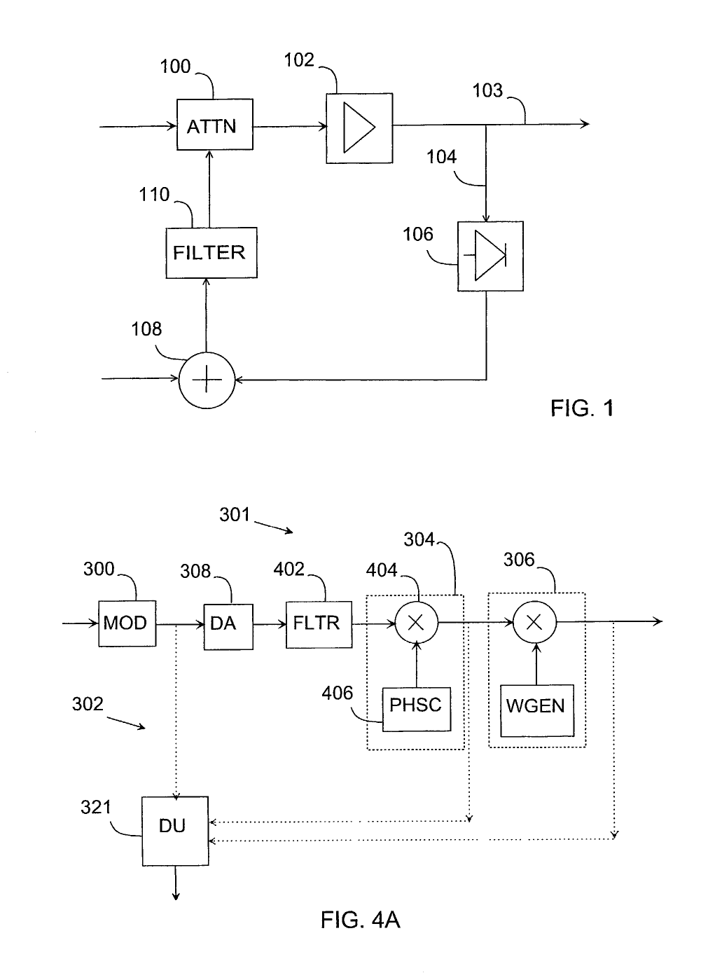

### DETAILED DESCRIPTION OF THE INVENTION

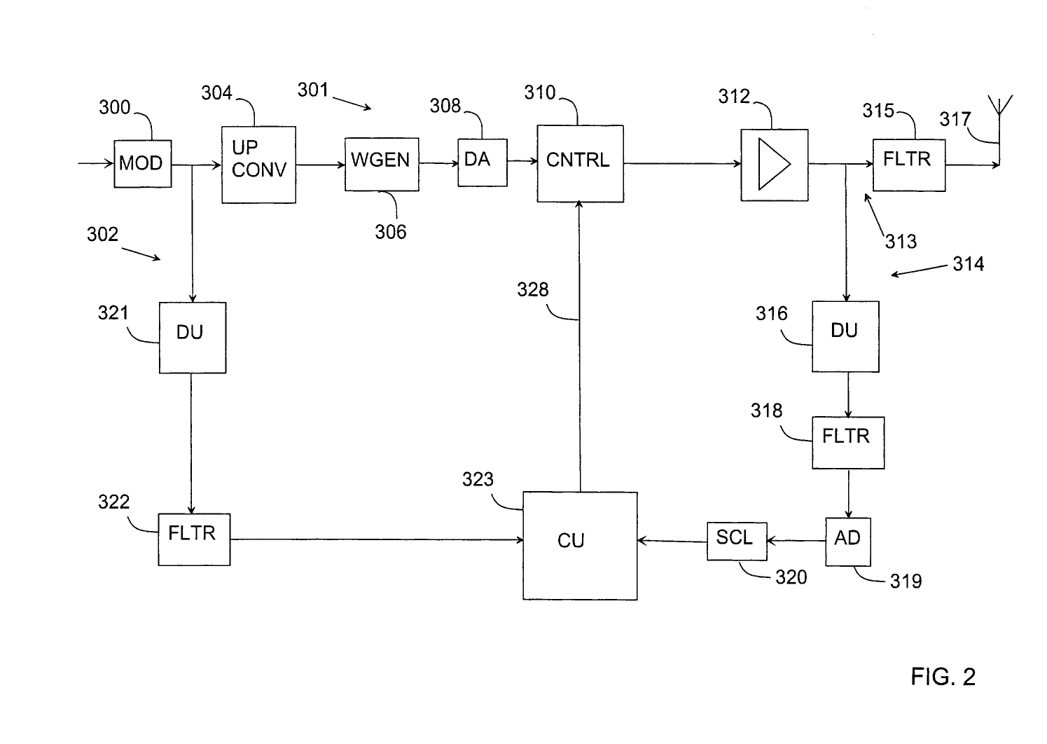

Signal modulation methods used in transmitters of a radio system are typically linear modulation methods. In linear modulation methods, the amplitude and phase of a signal are usually modulated. In the solution of the invention, gain control is provided upon linear modulation of a signal such that gain control does not distort the modulation. The solution of the invention is typically applicable to transmitters used in systems according to the TDMA technology (Time Division Multiple Access). In the block diagram of the transmitter according to the solution of the invention shown in FIG. 2, a modulator 300 modulates a digital input signal into a complex envelope. The modulated signal is applied to a main signal path 301 and to a reference signal path 302. On the main signal path, the modulated signal is applied to an up-converter 304, with which the signal is converted into at least one desired frequency. From the up-converter, the signal is applied to a windowing generator 306, with which the signal is divided into the desired timeslots. The windowing generator may be located at some other point on the main signal path 301 or for example in the modulator 300. The digital input signal is converted into an analog signal with a DA converter 308, typically after said window generation performed in the windowing generator.

A controller 310 is used for gain control based on the control signal in such a way that signal power at an output 313 is adjusted to the desired level. From the controller, the analog signal is applied to a power amplifier 312, which amplifies the signal to an output power level to the output 313, where the signal is filtered with an antenna filter 315 and transmitted with an antenna 317. The analog signal amplified by the power amplifier to the output is also applied to a feedback 314. At the feedback, the analog signal is detected with a detector unit 316, which may be located at some other point of the feedback than is shown in FIG. 2. The detector unit 316 may be a detector, which amplitude-detects the signal, or an absolute value generator, which generates the absolute value of the signal. Both the above may also constitute the detector unit. After detection, the signal is filtered with a filter 318. Filtering is typically anti alias filtering for AD conversion. The analog signal is converted into a digital signal with an AD converter 319. There are also second and third alternative ways to implement the above. In the second implementation, the signal, applied to the feedback, is first filtered, whereupon said analog signal is AD converted into a digital signal. In the second implementation, detection is carried out after AD conversion by digital detection of the digital signal. In the third embodiment, AD conversion is not carried out at all, i.e. the digital signal remains analog. Filtering is not either always necessary.

The power level of the feedback 314 signal is set with a power level adjuster 320, in order for said signal to be comparable in a desired way with a signal applied from the reference signal path 302. The power level adjuster may also be located on the reference signal path 302, in which case it is not necessarily needed in the feedback 314. The signal of the reference signal path 302 is detected with a detector unit 321 such that it is comparable with the feedback 314 signal. The detector unit 321 may be a detector or an absolute value generator, in the same way as the feedback detector unit 316. In the solution of the invention, for example a detector based on the detection of global maximum power values may constitute the detector unit 316, 321. The signal is typically filtered with a filter 322 on the reference signal path 302.

The above signals from the feedback 314 and the reference signal path 302 are applied to a control unit 323. In the control unit 323, at least one control signal is generated based on the comparison of said signals. The control signal may be a digital or an analog signal. At least one control signal is used to control at least one controller 310 via at least one control branch 328 for gain control to the desired level in a following at least one time-slot. By gain control, the power of a signal at the output 313 is adjusted towards the ideal value. Control may also be performed between timeslots. Said timeslots are timeslots into which the windowing generator 306 divided the signal. The control unit 323 is typically digitally implemented. The modulator 300 and the up-converter 304 may be digitally implemented. If analog signals are applied to the control unit from the feedback and the reference signal path, analog signal comparison may be performed in the control unit.

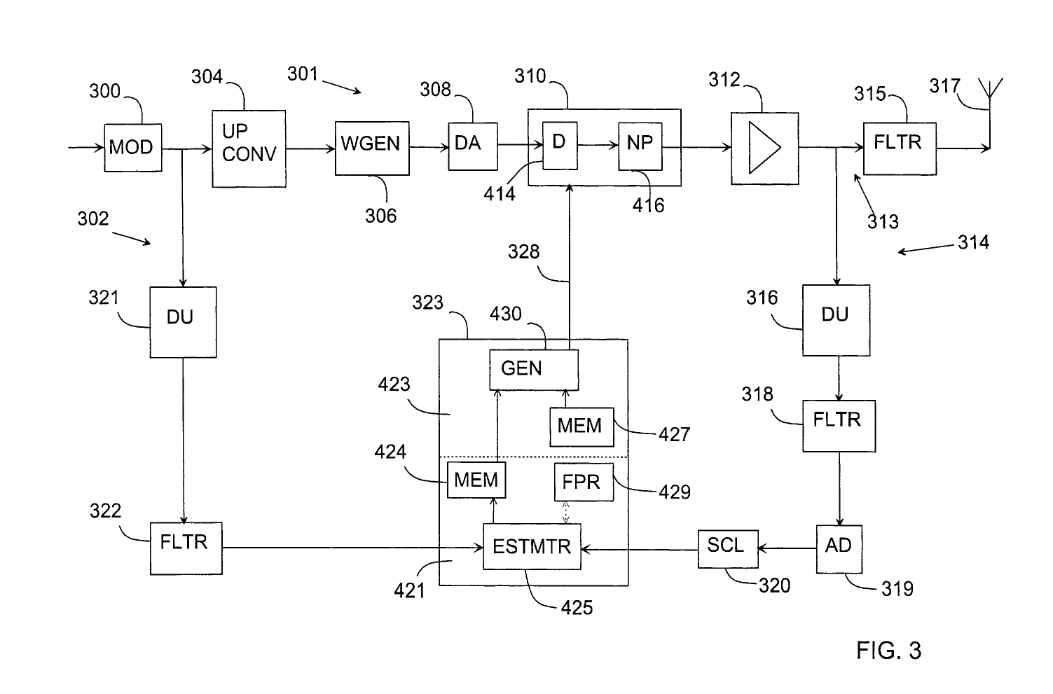

In the preferred embodiment of the invention shown in FIG. 3, a baseband modulator 300 modulates the digital symbols in a digital input signal into a complex envelope signal in a system conforming to the TDMA technology. The complex envelope signal is applied on the main signal path 301 to an up-converter 304 and to a detector unit 321 on the reference signal path 302. The up-converter 304 may be implemented digitally or analogically. FIG. 4A shows a solution according to analogically implemented up-conversion. A modulated digital signal is applied to the reference signal path 302 and to the main signal path 301. On the main signal path, the digital signal is converted with the DA converter 308 into an analog signal, where-upon the signal is filtered with a filter 402, which is typically a low-pass filter. The filtered complex envelope signal is converted into radio frequencies with a converter 404 and a phase shifter 406. A windowing generator 306 is used to generate timeslots conforming to the TDMA technology for the signal. With reference to FIG. 3, the signal may be applied to the detector unit 321 of the reference signal path 302 from the baseband modulator 300, whereby the signal is a complex envelope signal in digital form. The signal may also be applied to the detector unit 321 after the up-converter 304 as an analog signal at the points shown in FIG. 4A by broken arrows.

FIG. 4B shows a solution according to digitally implemented up-conversion. A modulated complex envelope signal is applied to the detector unit 321 on the reference signal path 302 and to an interpolator 411, with which the signals are interpolated. After interpolation, an oscillator 408 and a converter 410 are used to up-convert the complex envelope signal. The oscillator is typically a numerically controlled oscillator. The windowing generator 306 is used to generate the desired timeslots conforming to the TDMA technology for the signal, which may also be performed for the reference signal path 302. On the main signal path 301, said digital signal is converted after the windowing generator into an analog signal with the DA converter 308, and filtered with a filter 412, which is typically a low-pass filter. The signal may be applied to the detector unit 321 on the reference signal path 302 directly from the baseband modulator 300 or the signal may also be applied to the detector unit 321 after the up-converter as either a digital or an analog signal from the points shown in FIG. 4B by broken arrows.

The controller 310 in FIG. 3 may comprise at least one discrete controller 414 or at least one continuous controller 416 or at least one of both of said controllers. A discrete controller is based on discrete amplification or attenuation steps, and a continuous controller is based on continuous control. The control steps of a discrete controller may be e.g. 2 dB, whereby 15 control steps generate 30-dB dynamics. A continuous controller may comprise one or more voltage-regulated or current-regulated amplifiers or attenuators, or a combination of the above. Furthermore, correction controllers may be used for correcting errors due to the frequency responses of components or the temperature drift in transmitter amplification. The non-idealities of both a continuous and a discrete controller can be modelled into correction parameters that can be utilized in the generation of control signals. The controller or a part of the controller may also be located elsewhere than what is shown in FIGS. 2 and 3, e.g. in the modulator and/or up-converter. The solution of the invention may be implemented for example by performing discrete control at the point of the controller 310 shown in FIGS. 2 and 3, and fine adjustment for fine adjusting the discrete control with the controller for example in connection with windowing.

From the controller 310, the signal is applied to the power amplifier 312, which amplifies the signal to the desired output power level. The analog signal amplified by the power amplifier as an output signal at the output 313 is also applied to the feedback 314, via which the signal is applied to the control unit 323. The output signal is filtered at the output with an antenna filter 315, whereupon it is transmitted by the antenna 317. In the feedback, the analog signal is detected with the detector unit 316. Detection is typically continuous. From the detection, the information obtained in a period of time comprised by a measuring sequence is typically utilized. The amplitude values of an envelope are typically detected in detection. The measurement on which the detection is based can also be based on for example maximum amplitude values, the signal mean value or root-mean-square value.

The detected signal is filtered with the filter 318. The detected signal, which is in analog form, is converted into a digital signal with the AD converter 319, typically after the filtering performed with the filter 318. The power level of the feedback 314 signal is set to the desired level with the power level adjuster 320, in order for said signal to be comparable in the desired way with the signal detected on the reference signal path 302. On the reference signal path, detection can be carried out in the same way as feedback detection. The signal of the reference path is typically filtered with the filter 322 on the reference signal path 302. The power level adjuster may also be located on the reference signal path 302, whereby it is not necessarily needed in the feedback 314.

Said signals from the feedback 314 and the reference signal path 302 are applied to the control unit 323. The control unit comprises an error parameter unit 421 and a control signal generator 423. Said signals are compared in an error parameter estimator 425 comprised by the error parameter unit to generate error parameters. In the comparison of the signal of the reference signal path with the signal of the feedback, signal power values, such as local maximum power values and/or global maximum power values are compared to generate error parameters. Signals may also be modified in the error parameter unit as desired for the generation of error parameters. The error parameter unit 421 comprises an error parameter memory 424. The error parameters are applied to a control signal generator 423, which optionally, based also on other parameters, generates at least one control signal in a generation unit 430 comprised by the control signal generator 423. The control signal is used to control the controller 310 via the control branch 328 for gain control, in order for the output power of the transmitter to be on the desired level in a following at least one timeslot or between timeslots or in both of the above. Timeslots are timeslots into which the windowing generator 306 has divided the signal. In the solution of the invention for adjusting power by gain control, power adjustment can be stated to be non-real-time. The error parameter unit 421 and the control signal generator 423 are typically digitally implemented.

The above-described generation of error parameters is carrier out based on measuring sequences. A period of time comprised by one measuring sequence may be either one timeslot typical of the TDMA technology or a given part of a timeslot, e.g. the training sequence. During the measuring sequence, the required detection is carried out from the output signal. After detection, the feedback 314 signal or the signal of the reference signal path 302 or both of them are scaled before the estimation of error parameters. If both signals are in analog form, their analog difference can also be applied to the error parameter unit 421 for the generation of error parameters.

The feedback 314 signal and the signal of the reference signal path 302 are preferably compared in the error parameter unit 421 such that samples taken from a signal are weighted according to the signal amplitude so that low amplitude values are not so significant. For example, local maximums of the signals may be searched for and compared or the root-mean-square values of the signals may be compared. This avoids mistakes caused by the inaccuracy of the detection unit 316 at low signal values. Samples may also be rejected if the signal level of the sample is too low or if the signal level changes faster than the detection unit is able to follow. Accepted samples are processed to determine the strengths of the signal of the reference signal path and the feedback signal from the period of time comprised by the measuring sequence. Dividing the measuring sequence into periods of time allows signal strengths to be determined in detail, and thereby, the differences in strengths during the measuring sequence. The differences in strengths allow the amplification error of the transmitter in different TDMA timeslots to be determined. The periods of time comprised by the measuring sequence are typically at least of the length of a symbol comprised by the signal.

Part of the processing performed by the error parameter unit 421 can be comprised by the filters 318, 322 for example such that when said filters are slow, they use their slowness to compensate for the amplitude errors caused by delay differences between the reference signal path 302 and the feedback 314. Slow filters also allow a low sampling frequency for the error parameter unit.

If need be, the control signal generator 423 utilizes a memory unit 427 in whose memory the assumed signal amplification of the main signal path 301 can be stored in the first embodiment as a function of the control signals, and optionally as the function of other factors, such as power adjustment level, frequency, temperature and/or time. In the second embodiment, the assumed values of the control signals are stored in the memory of the memory unit 427 as a function of power adjustment levels, and optionally as the function of other factors, such as frequency, temperature and/or time. Said embodiments may be combined, if need be. For example the deviation of the real output signal from the assumed output signal at different points of time, estimated via detection, can be stored in the error parameter memory 424 of the error parameter unit 421. The control signal generator 423 generates control signals for different power adjustment levels based on the information stored in said memory unit 427 of the control signal generator and the error parameter memory 424 of the error parameter unit 421. A solution is feasible, wherein the control signal generator generates the control signal based on information stored in either the memory unit 427 or the error parameter memory 424. The preferred embodiment of the invention may also be implemented by implementing the memory unit and the error parameter memory as one unit for example by applying error parameter information directly to the memory unit 427, the information comprised by which is modified in such a way that the error parameter information is also included in the generation of the final information to be used in the generation of control signals for different power levels.

In the power level setting performed by the power level adjuster 320, the response of the feedback 312 is modelled such that when the signal power is the right one at the output of the transmitter, the error parameter unit 421 is correctly calibrated, i.e. it does not tend to change the situation unless there is cause for it. The response of the feedback can also be modelled to a response memory 429 of the error parameter unit, if need be.

The memory of the control unit 323 may comprise the response memory 429 of the error parameter unit 421 and the memory unit 427 of the control signal generator 423. The memory of the control unit may be updated when required for example by a control signal generated by the control unit.

The modelled responses of the main signal path 301 and the feedback 314 may also comprise responses of the parts succeeding the control system, such as an antenna filter, an antenna cable, an antenna booster, a power divider or responses of control couplings. This enables the compensation of the effect of these parts on the power of the signal applied to an antenna.

A control signal that remains in its constant value during a TDMA timeslot is called a static control signal. Control by static control signals may be performed with a discrete controller, such as a step controller. A control signal that changes during a TDMA timeslot is called a dynamic control signal. The use of a dynamical control signal requires a continuous controller. Control by dynamic control signals is required if the power of the arrangement changes excessively during a TDMA timeslot. If control by static control signals only is used, one error parameter per TDMA timeslot is enough. If control by dynamic control signals is used, several error parameters are required per TDMA timeslot.

In the following, two feasible control algorithms are described in detail. However, the invention is in no way restricted to the algorithms to be described next.

In the algorithm according to explicit control, the response memory of the error parameter unit comprises a nominal control signal:

Vcₙₒₘ=f(power adjustment level, [frequency], [temperature], [time])

The brackets [] indicate that the nominal control signal Vcₙₒₘ can be expressed as the function of the magnitudes in the brackets, if need be. The memory comprised by the error parameter unit 421 includes the required deviation of the control signal from the nominal value at different points of time in a period of time. These points of time represent the parts of different measuring sequences, wherein the error parameter unit 421 has compared the signals of the reference signal path with the feedback signals. If the measuring sequence is not divided into periods of time, only one error parameter exists and it includes the correction of the mean control signal of a measuring sequence:

Err=c(power adjustment level, [frequency], [temperature])

The brackets [] indicate that the mean control signal correction err can be expressed as the function of the magnitudes in the brackets, if need be.

When a measuring sequence is divided into periods of time, the above formula is as follows:

Errᵢ=c(power adjustment level, [frequency], [temperature], tᵢ)

Said formula defines the error parameters for different periods of time.

The control signal generator 423 calculates the required corrected control signal based on error parameters (assuming that N error parameters exist):

Vc=Vcₙₒₘ+interpolation function(time;err₁, err₂, . . . , err_{N}),

wherein the interpolation function can mean any known interpolation or curve adaptation method. The error parameter unit compares the strengths of the signal of the reference signal path and the feedback signal in different periods of time, as was described above. If there is a difference between the strengths, a correction in the direction of said difference is made in the corresponding error parameter. The correction is usually made such that the control arrangement does not overreact (i.e. become instable) or become too sensitive to measuring errors.

In the algorithm according to implicit control, the response memory 429 of the error parameter unit 421 comprises a control signal Gₑₓₚ according to the expected gain as a function of power adjustment level, temperature and/or time:

Gₑₓₚ=g(control signal, [power adjustment level], [frequency], [temperature], [time])

The brackets [] indicate that the control signal Gₑₓₚ according to the expected gain can be expressed as the function of the magnitudes in the brackets, if need be. The error parameter memory 424 of the error parameter unit 421 includes parameters that describe the deviation of the gain from the expected value. These parameters may be functions of for example the level of gain control, frequency or temperature. Let us assume that N error parameters exit. The control signal generator uses them to interpret the deviation by means of function h:

G_{dev}=h(time; err₁, err₂, . . . , err_{N}).

The deviation of the gain may also be defined as follows:

G_{dev}=h(control signal, [power adjustment level], [frequency], [temperature], [time])

The brackets [] indicate that the deviation of the gain G_{dev} may be expressed as the function of the magnitudes in the brackets, if need be.

The control signal generator now knows the corrected gain of the transmitter:

G_{corr}=Gₑₓₚ+G_{dev}

In the implicit power adjustment algorithm, a control signal is searched for, whereby G_{corr} becomes equal to the desired gain in a given TDMA timeslot.

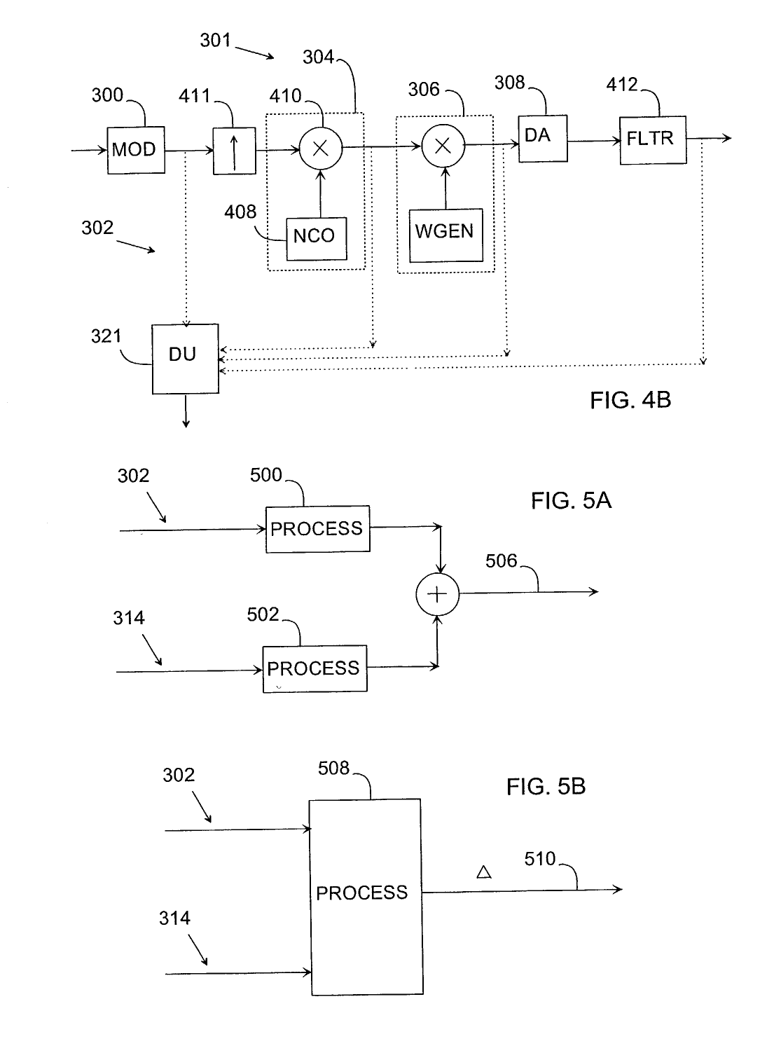

FIGS. 5A and 5B show processing models for the signals of the reference signal path and the feedback. FIG. 5A shows a parallel signal processing model, wherein the signals of the reference signal path 302 and the feedback 314 are processed in the desired manner separately 500, 502 to generate processing results. A first processing result is generated from the signal of the reference signal path, i.e. the signal applied to the control unit 323 before the power amplifier 312, and a second processing result is generated from the feedback signal, i.e. the signal applied to the control unit 323 from the output 313. The processing results are compared with each other to generate a control signal 506, which comprises information on the differences between the strengths of the signals of the reference signal path and the feedback for gain control.

FIG. 5B shows a processing model wherein the signals of the reference signal path 302 and the feedback 314 are processed together 508. In the processing, the signals of the reference signal path and the feed-back are processed and the signals of the reference signal path and the feed-back are compared by generating a control signal 510, which comprises information on the differences between the strengths of the signals of the reference signal path and the feedback for gain control. A mathematical algorithm, e.g. the LMS algorithm (Least Mean Square) may be used in the above generation of the control signal 510. The algorithm defines the delay between the signals of the reference signal path and the feedback, and the difference between the strengths of said signals. The algorithm uses the above to generate the control signal 510 for gain control.

The at least one control signal 506, 510 generated from the processing described above in connection with FIGS. 5A and 5B can be used to update the information on the transmitter response stored in the memory of the control unit 323. The steps described in connection with FIGS. 5A and 5B are typically performed in the control unit 323. Signal processing may be based on weighted signal values. Signals can be processed for example by integration. Part of signal processing may also be performed in one or more filters 318, 322. Signal processing may also be performed in one or more detector units 316, 321, such as in a detector based on the detection of global maximum power values, of which type e.g. detector unit 316, 321 can be. The control unit 323 may also comprise one or more filters for signal processing, the one or more filters being located somewhere on the signal path of the control unit, such as e.g. in the error parameter estimator 425. The above one or more filters may be an analog and/or digital filter.

The error parameter unit 421 and the control signal generator 423 or parts thereof may be implemented processor-based or logics-based.

In the solution of the invention, the gain control based on a control signal generated by the control unit 323 can also be performed on a digital signal before the power amplifier 312.

To summarize, it may be stated that in the solution of the invention, a comparison between the feedback signal and the signal of the reference signal path is performed, error parameters are generated based on said comparison and/or previous error parameters, and control signals based on the error parameters are used to control at least one controller in the next timeslot(s) to adjust the powers of output signals to ideal values or as close as possible to ideal values. The error parameters are updated, if need be.

The parts included in the present specification, whose implementations have not been described, at least not in detail, are implemented in accordance with prior art.

Although the invention is described above with reference to examples according to the accompanying figures, it is apparent that the invention is not limited thereto, but can be modified in a variety of ways within the scope of the inventive idea disclosed in the attached claims.

We claim:

1. An arrangement for gain control, the arrangement comprising a modulator for modulating a signal and a power amplifier for amplifying the modulated signal to an output, the arrangement further comprising:
a control unit for comparing a modulated signal of a given timeslot, applied to the control unit before the power amplifier, with a modulated amplified signal of said given timeslot, applied to the control unit after the power amplifier, and for generating a control signal based on said comparison, and
a controller for gain control in a following at least one timeslot based on the control signal.

2. An arrangement for gain control, the arrangement comprising a modulator for modulating a signal and a power amplifier for amplifying the modulated signal to an output, the arrangement further comprising:
a control unit for comparing a modulated signal of a given timeslot, applied to the control unit before the power amplifier, with a modulated amplified signal of said given timeslot, applied to the control unit after the power amplifier, and for generating a control signal based on said comparison, and
a controller for gain control between timeslots based on the control signal.

3. The arrangement as claimed in claim 1 or 2, further comprising a detector unit for detecting or creating the absolute value of the signal to be applied.

4. The arrangement as claimed in claim 1 or 2, further comprising a detector unit for detecting and creating the absolute value of the signal to be applied.

5. The arrangement as claimed in claim 1 or 2, wherein the timeslot is a timeslot according to the TDMA technology (Time Division Multiple Access).

6. The arrangement as claimed in claim 1 or 2, the arrangement further comprising a control unit for comparing the signals in at least one measuring sequence comprising a timeslot according to the TDMA technology (Time Division Multiple Access).

7. The arrangement as claimed in claim 1 or 2, the arrangement further comprising a control unit for comparing signal power values.

8. The arrangement as claimed in claim 1 or 2, the arrangement further comprising a control unit for comparing the local maximum power values of signals.

9. The arrangement as claimed in claim 1 or 2, the arrangement further comprising a control unit for comparing the global maximum power values of signals.

10. The arrangement as claimed in claim 1 or 2, the arrangement further comprising a control unit for generating a first processing result from the signal applied to the control unit before the power amplifier and for generating a second processing result from the signal applied to the control unit from the output.

11. The arrangement as claimed in claim 1 or 2, the arrangement further comprising a control unit for comparing the processing results for the generation of a control signal.

12. The arrangement as claimed in claim 1 or 2, the arrangement further comprising a control unit for processing signals by integration.

13. The arrangement as claimed in claim 1 or 2, the arrangement further comprising a control unit for processing signals based on weighted signal values.

14. The arrangement as claimed in claim 1 or 2, the arrangement further comprising a control unit for comparing the processed signals for the generation of a control signal.

15. The arrangement as claimed in claim 1 or 2, the arrangement further comprising one or more filters for performing part of the signal processing.

16. The arrangement as claimed in claim 1 or 2, the arrangement further comprising one or more detector units for performing part of the signal processing.

17. The arrangement as claimed in claim 1 or 2, wherein the control unit comprises an error parameter unit for generating error parameters and a control signal generator for generating at least one control signal based on the above error parameters.

18. The arrangement as claimed in claim 1 or 2, the arrangement further comprising a power level adjuster for adjustment the power level of the signal to be applied to the control unit to be comparable with the signal to be compared.

19. The arrangement as claimed in claim 1 or 2, wherein the control unit comprises one or more filters for processing.

20. The arrangement as claimed in claim 1 or 2, wherein the control unit comprises a memory, in which error parameters or a previously modelled arrangement response is stored.

21. The arrangement as claimed in claim 1 or 2, wherein the control unit comprises a memory, in which error parameters and a previously modelled arrangement response is stored.

22. The arrangement as claimed in claim 1 or 2, the arrangement further comprising a control unit for generating a control signal based on error parameters or a previously modelled arrangement response.

23. The arrangement as claimed in claim 1 or 2, the arrangement further comprising a control unit for generating a control signal based on error parameters and a previously modelled arrangement response.

24. The arrangement as claimed in claim 1 or 2, the arrangement further comprising a control unit, whose memory is updated, if need be.

25. The arrangement as claimed in claim 1 or 2, wherein the controller comprises a discrete controller.

26. The arrangement as claimed in claim 1 or 2, wherein the controller comprises a continuous controller.

27. The arrangement as claimed in claim 1 or 2, the arrangement further comprising a control unit for gain control based on a control signal on a digital signal before the power amplifier.

28. A method for gain control, in which method a signal is modulated and the modulated signal is amplified with a power amplifier to an output, comprising
applying a modulated signal of a given timeslot before the power amplifier to a control unit,
applying said amplified modulated signal from the output to the control unit,
comparing the signals in the control unit,
generating a control signal in the control unit, based on the comparison
controlling the gain based on the control signal in a following at least one timeslot.

29. A method for gain control, in which method a signal is modulated and the modulated signal is amplified with a power amplifier to an output, comprising
applying a modulated signal of a given timeslot before the power amplifier to a control unit,
applying said amplified modulated signal from the output to the control unit,
comparing the signals in the control unit,
generating a control signal in the control unit, based on the comparison,
controlling the gain based on the control signal between timeslots.

30. The method as claimed in claim 28 or 29, wherein the signal is applied detected or as an absolute value.

31. The method as claimed in claim 28 or 29, wherein the signal is applied detected and as an absolute value.

32. The method as claimed in claim 28 or 29, wherein the timeslot is a timeslot according to the TDMA technology (Time Division Multiple Access).

33. The method as claimed in claim 28 or 29, wherein the signals are compared in at least one measuring sequence comprising a timeslot according to the TDMA technology (Time Division Multiple Access).

34. The method as claimed in claim 28 or 29, wherein the signal power values are compared in the comparison.

35. The method as claimed in claim 28 or 29, wherein the local maximum power values of signals are compared in the comparison.

36. The method as claimed in claim 28 or 29, wherein the global maximum power values of signals are compared in the comparison.

37. The method as claimed in claim 28 or 29, wherein a first processing result is generated from the signal applied to the control unit before the power amplifier and a second processing result is generated from the signal applied to the control unit from the output.

38. The method as claimed in claim 28 or 29, wherein the processing results are compared with each other to generate a control signal.

39. The method as claimed in claim 28 or 29, wherein the signals are processed by integration.

40. The method as claimed in claim 28 or 29, wherein the processing of the signals is based on weighted signal values.

41. The method as claimed in claim 28 or 29, wherein the processed signals are compared to generate a control signal.

42. The method as claimed in claim 28 or 29, wherein the processing of the signals is partly performed by filtering with filters.

43. The method as claimed in claim 28 or 29, wherein the processing of the signals is performed in one or more detector units.

44. The method as claimed in claim 28 or 29, wherein error parameters are generated in the control unit, based on which a control signal is generated in the control unit.

45. The method as claimed in claim 28 or 29, wherein the power level of the signal to be applied to the control unit is set to be comparable with the signal to be compared.

46. The method as claimed in claim 28 or 29, wherein the processing is performed by filtering with one or more filters comprised by the control unit.

47. The method as claimed in claim 28 or 29, wherein the error parameters or the previously modelled arrangement response are stored in the memory of the control unit.

48. The method as claimed in claim 28 or 29, wherein the error parameters and the previously modelled arrangement response are stored in the memory of the control unit.

49. The method as claimed in claim 28 or 29, wherein a control signal is generated in the control unit based on the error parameters or the previously modelled arrangement response.

50. The method as claimed in claim 28 or 29, wherein a control signal is generated in the control unit based on the error parameters and the previously modelled arrangement response.

51. The method as claimed in claim 28 or 29, wherein the memory of the control unit is updated when necessary.

52. The method as claimed in claim 28 or 29, wherein the gain control based on the control signal is performed with a controller, which is a discrete controller.

53. The method as claimed in claim 28 or 29, wherein the gain control based on the control signal is performed with a controller, which is a continuous controller.

54. The method as claimed in claim 28 or 29, wherein the gain control based on the control is performed signal on a digital signal before the power amplifier.
